(19) United States
(12) Patent Application Publication
(10) Pub. No.: US 2024/0020017 A1
(43) Pub. Date: Jan. 18, 2024

(54) MONITORING METHOD AND APPARATUS FOR ELECTRONIC DEVICE, AND ELECTRONIC DEVICE

(71) Applicant: QISDA (SUZHOU) CO., LTD., Suzhou City, Jiangsu (CN)

(72) Inventor: Dan QIAN, Suzhou City (CN)

(73) Assignee: QISDA (SUZHOU) CO., LTD., Suzhou City, Jiangsu (CN)

(21) Appl. No.: 18/254,933

(22) PCT Filed: Mar. 24, 2022
(86) PCT No.: PCT/CN2022/082748

§ 371 Date: May 30, 2023

(51) Int. Cl. G06F 3/06

(52) U.S. Cl. CPC G06F 3/0616; G06F 3/0653; G06F 3/0679

(57) ABSTRACT

A monitoring method for an electronic device configured with an embedded flash memory. The monitoring method includes: acquiring service life data and access status data of the embedded flash memory; performing statistics on the access status data to obtain a statistical result of the access status; generating early warning information if it is determined according to the service life data and/or the access status data that an early warning condition is met; and reporting and displaying the service life data and the statistical result of the access status according to the early warning information. Through real-time monitoring on an electronic device with an embedded flash memory module, when the service life loss of the embedded flash memory reaches a preset range or the usage status of the embedded flash memory reaches a preset condition, a user can be warned and provided with a viewing interface.

### TECHNICAL FIELD

The invention relates to the technical field of storage devices, in particular to a monitoring method and apparatus for an electronic device, and an electronic device.

### BACKGROUND

Embedded flash memories such as Embedded Multi Media Card (eMMC) and Universal Flash Storage (UFS) are commonly used storage media in many electronic devices. In daily use, the service life of storage media will decrease with continuous access. In this regard, storage devices are also consumables. Devices with more access scenarios have a higher loss rate. If the service life of an embedded flash memory is excessively consumed, a device using the flash memory may have the following problems: slow software running speed, system lagging, inaccessible files or data damage, irregular software crashing or system restart, and failure to boot.

The above problems will cause great losses to users, including failure to use the device and damage or loss of important data stored in the device. Therefore, it is very important to monitor the service life of flash memories and give an early warning when needed. However, for current products, whether in the case of a built-in system or third-party software, although there are many warning tools, such as power status warning, traffic usage warning, screen defect detection, etc., warning for the service life of storage devices is unavailable, so users cannot be warned of the problems listed above.

### SUMMARY

The application aims to provide a monitoring method and apparatus for an electronic device, which provide a mechanism for monitoring the service life of an embedded flash memory in real time and acquiring the usage status of the embedded flash memory. When a preset warning condition is met, early warning information is sent to a user, and corresponding data are displayed to the user through a user-friendly interface.

According to one aspect of the application, a monitoring method for an electronic device configured with an embedded flash memory is provided. The monitoring method comprises:
acquiring service life data and access status data of the embedded flash memory;
performing statistics on the access status data to obtain a statistical result of the access status;
generating early warning information if it is determined according to the service life data and/or the access status data that an early warning condition is met; and
reporting and displaying the service life data and the statistical result of the access status according to the early warning information.

According to some embodiments, the method further comprises:
actively acquiring the service life data and the statistical result of the access status.

According to some embodiments, the method further comprises:

storing the service life data and the access status data in a database.

According to some embodiments, in the method, reporting and displaying the service life data and the statistical result of the access status comprises:
displaying a change of the embedded flash memory itself based on time span.

According to some embodiments, in the method, reporting and displaying the service life data and the statistical result of the access status further comprises:
displaying a service life loss status compared with other embedded flash memories.

According to some embodiments, in the method, reporting and displaying the service life data and the statistical result of the access status further comprises:
filtering the service life data and the access status data according to different filtering conditions.

According to some embodiments, in the method, reporting and displaying the service life data and the statistical result of the access status further comprises:
displaying the service life data and the access status data in sequence according to specified criteria.

According to some embodiments, the method further comprises:
monitoring the early warning information and acquiring the service life data and the access status data; and
notifying or sharing the early warning information and/or the acquired service life data and access status data to other monitors or devices.

According to some embodiments, in the method, a plurality of monitor processes perform the monitoring at the same time.

According to some embodiments, the method further comprises:
acquiring an instruction of the monitor, and processing the acquired service life data and access status data to protect the embedded flash memory.

According to another aspect of the application, a monitoring apparatus for an electronic device is provided, comprising:
an acquisition module configured to acquire service life data and access status data of the embedded flash memory;
a processing module configured to process the service life data;
a statistics module configured to perform statistics on the access status data;
a warning module configured to generate early warning information if it is determined according to the service life data and/or the access status data that an early warning condition is met; and
a reporting and displaying module configured to report and display the service life data and the statistical result of the access status according to the early warning information.

According to another aspect of the application, an electronic device is provided, comprising:
a memory, a processor and a computer program stored in the memory and runnable on the processor, wherein the processor executes the computer program to implement any one of the above methods.

According to another aspect of the application, a computer program product is provided, comprising computer programs or instructions, wherein the computer programs or instructions are executed by a processor to implement any one of the above methods.

According to exemplary embodiments of the application, through real-time monitoring on an electronic device with an embedded flash memory module, when the service life loss of the embedded flash memory reaches a preset range or the usage status of the embedded flash memory reaches a preset condition, a user can be warned and provided with a viewing interface.

According to exemplary embodiments of the application, by viewing the gathered access information, including program access frequency ranking, access statistics in each time period, etc., the possible reasons for shortening the service life of the embedded flash memory can be learned, and users can be helped to evaluate and improve their device using habits, so as to indirectly slow down the loss of the flash memory to a certain extent in the future.

It should be understood that the above general description and the following detailed description are only exemplary, and do not limit the application.

### BRIEF DESCRIPTION OF THE DRAWINGS

In order to more clearly explain the technical solutions of the embodiments of the application, the drawings needed in the description of the embodiments are briefly set forth below.

FIG. 1 shows a flowchart of a method for warning the service life of an eMMC hard disk according to an exemplary embodiment of the application.

FIG. 2 shows a frame diagram of a basic mechanism for warning the service life of an eMMC hard disk according to an exemplary embodiment of the application.

FIG. 3 shows a diagram of an eMMC service life loss curve according to an exemplary embodiment of the application.

FIG. 4 shows a statistical report data display diagram according to an exemplary embodiment of the application.

FIG. 5 shows a diagram of block device access statistics by date according to an exemplary embodiment of the application.

FIG. 6 shows a diagram of block device access statistics by usage ranking according to an exemplary embodiment of the application.

FIG. 7 shows a diagram of block device access statistics by filtering and ranking conditions according to an exemplary embodiment of the application.

FIG. 8 shows a diagram of file access ranking by accessor frequency according to an exemplary embodiment of the application.

FIG. 9 shows a block diagram of an apparatus for warning the service life of an eMMC hard disk according to an exemplary embodiment of the application.

FIG. 10 shows a block diagram of an electronic device according to an exemplary embodiment.

### DETAILED DESCRIPTION OF EMBODIMENTS

Exemplary embodiments will be described more fully below with reference to the accompanying drawings. However, the exemplary embodiments can be implemented in various forms and should not be construed as a limit to the embodiments set forth herein. These embodiments are provided to make this application more thorough and complete, and to fully convey the concept of the exemplary embodiments to those skilled in the art. In the drawings, the same reference signs refer to the same or similar parts, so repeated descriptions will be omitted.

In addition, the described features, structures, or characteristics may be combined in any suitable manner in one or more embodiments. In the following description, numerous specific details are provided to give a thorough understanding of the embodiments of the application. However, those skilled in the art will realize that the technical solution of the application can be practiced without one or more of the specific details, or other methods, components, devices, steps, etc. can be adopted. In other cases, well-known methods, devices, implementations or operations are not shown or described in detail to avoid obscuring aspects of the application.

The block diagrams shown in the drawings are only functional entities and do not necessarily correspond to physically independent entities. That is, these functional entities can be implemented in the form of software, or in one or more hardware modules or integrated circuits, or in different networks and/or processor devices and/or microcontroller devices.

The flowchart shown in the drawings is only an exemplary illustration, and does not necessarily include all contents and operations/steps, nor does it have to be executed in the described order. For example, some operations/steps can be decomposed, while some operations/steps can be combined or partially combined, so the actual execution order may change according to the actual situation.

It should be understood that although the terms like “first”, “second” and “third” may be used herein to describe various components, these components should not be limited by these terms. These terms are used to distinguish one component from another. Therefore, the first component described below can be referred to as the second component without departing from the teaching of the concept of this application. As used herein, the term “and/or” includes any one and all combinations of one or more of the associated listed items.

Those skilled in the art can understand that the drawings are only diagrams of the exemplary embodiments. The modules or processes in the drawings are not necessarily a must for the implementation of this application, so they cannot be used to limit the scope of this application.

The main idea of the application is to monitor an electronic device with an embedded flash memory module in real time, and when the service life loss of the embedded flash memory reaches a preset range or the usage status of the embedded flash memory reaches a preset condition, a user can be warned and provided with a viewing interface.

In recent years, with the application and development of flash memory technology, both hard disks on computers and storage devices in mobile phones are becoming faster and faster. The speed of memory cards on mobile phones is getting increasingly faster, whether it is SD card, or eMMC card or UFS card.

Embedded Multi Media Card (EMMC) is a standard specification for embedded memories made by MMC Association, which is mainly aimed at products such as mobile phones or tablet computers. UFS protocol is formulated by JEDEC (www.jedec.org), and eMMC, like UFS, is also a mobile storage protocol formulated by JEDEC.

The following description is based on eMMC devices.

A specific method for acquiring the service life of eMMC proposed in this application follows the rules of eMMC specification, thus having high compatibility and a wide application range. Generally speaking, regular eMMC devices must strictly follow the specification definition, so the method for “acquiring service life information” in this application can be effective on any regular eMMC device.

Due to the fact that the specific implementations of different manufacturers vary and the service life information provided by some manufacturers may be inaccurate due to technical problems, this application puts forward “access status statistics” for auxiliary statistics to further confirm whether there are too many or too frequent accesses.

The core of this application is to play a warning role for users. Although the service life of eMMC cannot be recovered after warning, it can still play a positive role in the following aspects.

The idea of “access status statistics” is provided. After receiving the warning, users can view gathered access information, including program access frequency ranking, access statistics in each time period, etc., to help users understand the possible reasons for shortening the service life of eMMC and also help users evaluate and improve their device using habits. To some extent, this can indirectly slow down the consumption of eMMC in the future.

After acquiring the service life information of eMMC, users can make necessary data backup, transfer or eMMC replacement in advance to reduce losses.

If the service life of eMMC has expired or is about to expire, users can consider the problem of eMMC first when defective conditions as mentioned above occur, instead of making unnecessary maintenance, thus saving maintenance time and cost and improving maintenance efficiency.

For non-individual users, such as purchasing units of raw materials, the “service life loss curve” provided in this application can be considered as an evaluation factor during purchasing, and the degrees of life reduction of different chips under the same environment, configuration and using habits can be checked. In this way, raw materials with higher durability can be selected and the overall product quality can be improved.

For R&D units, if eMMC over-consumption occurs for devices, the “service life loss curve” in this application helps to determine whether the problem is an individual problem or a universal problem, and “access status statistics” helps to locate the regularity of the problem.

The core of this application is to provide a mechanism for monitoring the service life of eMMC in real time and acquiring the usage status of eMMC. When a preset warning condition is met, early warning information is sent to a user, and corresponding data are displayed to the user through a user-friendly interface.

The mechanism of this application may comprise three programs: monitoring program, information providing program and information processing program.

The monitoring program is to trigger the monitoring of a service life value of eMMC and the collection of the usage status of eMMC according to a configured condition, and perform warning.

The information providing program mainly refers to modules related to the activation and use of eMMC in a system, and provides original data for the monitoring program.

The information processing program mainly refers to an upper processing program, which monitors broadcasts of the monitoring program, and receives and processes data provided by the monitoring program.

Exemplary embodiments of the application are described below with reference to the accompanying drawings.

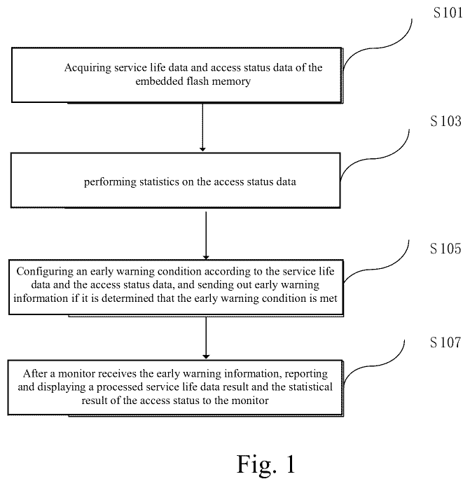

FIG. 1 shows a flowchart of a method for warning the service life of an eMMC hard disk according to an exemplary embodiment of the application.

Referring to FIG. 1, in S101, service life data and access status data of an embedded flash memory are acquired.

The following description is based on eMMC devices.

The function of the information providing program is to provide required source data to the monitoring program. There are two types of data involved in this application: service life data of eMMC, and data related to the access status of eMMC. Any program that can provide these two types of data can be used as an information providing program.

A service life data provider is required to be able to acquire or estimate the service life value of eMMC. For example, when using the way of reading the value of an ext_csd register (the meaning of this register value is described in the industry specification “JEDEC Standard No. 84-B51”), a corresponding service life information providing program must be able to access the register of eMMC and read the value of a specified bit. In the system, an underlying driving program of an eMMC module is generally capable of this.

A provider of eMMC access information is required to be able to acquire the information of reading and writing operations on eMMC. The programs with these capabilities in the system include (but are not limited to):
an underlying block device driver which can get access information at the block level, such as the number of blocks read and written and the PID of an accessor; and
a file system which can get access information at the file level, such as file path name, access time and other information.

The service life data and access status data of eMMC are obtained by the above methods or other methods than the above.

In terms of the specific initiation mode of information transmission, the monitoring program can not only query the information providing program as an active initiator of each transmission (by polling, etc.), but also receive information sent by the information providing program as a passive listener (by interruption or monitoring, etc.).

Due to the variety of products in the eMMC market, in order to be compatible with more eMMC and make the method of this application to be accurately adaptable to more products, a specific method for acquiring the service life value is considered in this application, that is, relevant parameters defined in the industry standard are adopted as a monitoring target. Because of the adoption of parameters defined in the industry standard, as long as it is an eMMC product that meets the standard, no matter how distinctive it is, the final read values can be unified in terms of meaning, format and numerical range. In this way, the problem of compatibility is solved.

After strict comparison and filtering, in this application, bits 269, 268 and 267 of the ext_csd register specified in the industry standard “JEDEC Standard No. 84-B51” are selected as the target parameters of the eMMC life of a product, and the register is monitored.

The following are descriptions of the three bits of data in the standard.

The description of bits 268 and 269 of the ext_csd register in the JEDEC standard is shown in the left chart below, and the description of bit 267 of the ext_csd register in the JEDEC standard is shown in the right chart below.

| 0x00 | Not defined | 0x00 | Not Defined |
|---|---|---|---|
| 0x01 | 0% [symbol] 10% d [symbol] | 0x01 | Normal |
| 0x02 | 10% [symbol] 20% d [symbol] | 0x02 | Warning |
| 0x03 | 20% [symbol] 30% d [symbol] | 0x03 | Urgent |
| 0x04 | 30% [symbol] 40% [symbol] | 0x04~0xFF | Reserved |
| 0x05 | 40% [symbol] 50% [symbol] | | |
| 0x06 | 50% [symbol] 60% [symbol] | | |
| 0x07 | 60% [symbol] 70% [symbol] | | |
| 0x08 | 70% [symbol] 80% [symbol] | | |
| 0x09 | 80% [symbol] 90% [symbol] | | |
| 0x0A | 90% [symbol] 100% [symbol] | | |

[symbol]

indicates data missing or illegible when filed

269 and 268 are the same in nature, which both record the consumed percentage, just for different types of eMMC. Therefore, during implementation, a developer should make sure that a selected register bit is matched with the eMMC type of a product.

If bit 269 or 268 is taken as the service life value, the alarm condition can be set as the read value is greater than a certain percentage; and if bit 267 is taken as the service life value, the alarm condition can be set as the average residual block is at the Waring or Urgent level.

269/268 is preferred between the two, or 269/289 and 267 can be monitored at the same time.

Other methods to acquire the service life value include, for example, estimation based on the number of revolutions, estimation based on the block usage ratio, etc.

In S103, statistics is performed on the access status data.

For the collection of access information, information about reading and writing operations on eMMC can be acquired. The programs with these capabilities in the system include: an underlaying block device driver which can get access information at the block level, such as the number of blocks read and written and the PID of an accessor; a file system which can get access information at the file level, such as file path name, access time and other information; and other related modules, such as Android storaged program.

Users can view the gathered access information, including program access frequency ranking, access statistics in each time period, etc., so as to understand the possible reasons for shortening the service life of eMMC and evaluate and improve their device using habits. To some extent, this can indirectly slow down the consumption of eMMC in the future.

In S105, an early warning condition is configured according to the service life data and the access status data, and early warning information is sent out if it is determined that the early warning condition is met.

According to some embodiments, the early warning trigger condition may be whether the service life value of eMMC reaches a preset condition. Triggering early warning means that when the monitored data reach the pre-configured early warning condition, the monitoring program sends an alarm signal to the information processing program.

Other conditions can be added as appropriate according to the actual situation. If some items in the collected access information need special attention, an early warning condition can also be set for these data, and an early warning can be given when the condition is met. For example, for a system-sensitive file under a certain path, if it is found that the number of access times is more than a certain number in a certain period of time, an early warning can be given.

The way of an alarm signal is related to a product development platform. For example, in an Android system, a underlaying kernel event (send to all, and a receiver does not need to register in advance), an upper broadcast mechanism (a receiver needs to register in advance), and a more public signal mechanism (a receiver defines a signal processing function in advance) can be used. Other platforms also have their mutual notification mechanism between processes.

If the service life of eMMC has expired or is about to expire, users can consider the problem of eMMC first when defective conditions as mentioned above occur, instead of making unnecessary maintenance, thus saving maintenance time and cost and improving maintenance efficiency.

In S107, after a monitor receives the early warning information, the service life data and the statistical result of the access status are reported and displayed to the monitor.

The information processing program, that is, the monitor of an early warning event, can ask the monitoring program for the service life information and access status information of eMMC after receiving the early warning information, and then process the information.

There can be multiple monitors, which may be programs developed by the original factory or third-party programs. If it is necessary to restrict the identity of the monitor, a security-related mechanism can be provided in the system for protection, such as blacklist and whitelist, permission configuration and so on.

The monitor at least provides the function of “displaying statistical reports”, including “service life information display” and “access status statistics”. In addition, the monitor can also perform other processing operations, including other utilization of the original data, or protection (such as access restriction, data relocation, temperature control, performance mode adjustment, etc.) for insufficient service life.

At any time when the early warning information is not received, the information processing program can also actively send a search request to the monitoring program to acquire data.

According to some embodiments, “service life information display” means displaying information to the user, that is, the user is notified as soon as the early warning information is received. The way of notification can be designed according to the capabilities of the device/platform, for example, with a pop-up dialog box, a status bar, a warning sound, a breathing light and so on. When giving an alarm, the current eMMC service life information (such as consumption percentage) of the device is displayed at least.

An interface can be provided so that the user can check the service life loss of the eMMC of the machine and a contrasted condition at any time. In order to realize the comparison function, the information processing program needs to store information into a database each time the information is acquired.

Comparison includes: time comparison, which shows a variation chart of the device itself by time span (for example, by week/month/quarter); and device comparison, which shows the eMMC loss chart of other devices (provided that the compared device has also adopted the mechanism in this application, which is recorded in the database). See FIG. 4 for a specific example of how access statistics are displayed.

After acquiring the service life information of eMMC, the user can make necessary data backup, transfer or eMMC replacement in advance to reduce losses.

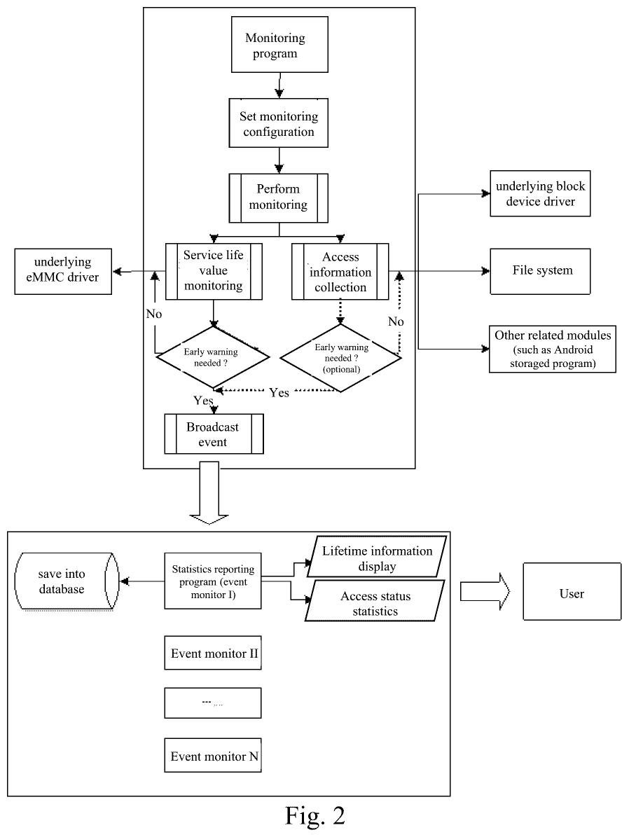

FIG. 2 shows a frame diagram of a basic mechanism for monitoring the service life of an eMMC hard disk according to an exemplary embodiment of the application.

Refer to FIG. 2, monitoring configuration is set by the monitoring program, and the configuration information at least includes a triggering condition of monitoring and a triggering condition of early warning, for example, the monitoring conditions are triggered periodically, and the monitoring program needs to request data from the information providing program at a certain time interval; and the early warning condition is triggered by threshold, that is, when the service life value reaches a certain value, early warning is triggered.

A developer can set and adjust trigger condition according to the actual situation of products (the above examples are referable but not limiting). Among the early warning condition, at least the condition that trigger early warning according to the service life information must be met. A developer can also add other configuration information according to the actual situation of products, such as the on/off settings of the monitoring program itself.

When the system meets the preset monitoring triggering condition, the monitoring program performs monitoring in the background. There are two main monitoring items proposed in this application: service life value monitoring and access information monitoring. A provider of the eMMC access information is required to be able to acquire the information of reading and writing operations on eMMC.

Generally, the service life value is acquired through an underlying driving program of an eMMC module. The access information can be collected through an underlaying block device driver, a file system and other related modules, such as Android storaged program.

The monitoring is realized as follows: the monitoring program establishes connection with the information providing program, and then queries the information providing program about related data (service life or eMMC access information) according to the monitoring requirements configured in the configuration (such as monitoring duration, monitoring interval, monitoring cycle, etc.). “Establishing connection” refers to creating data channel interfaces that can be provided by a development platform, such as sysfs channel, ioctl channel and Share Memory channel of an underlying Linux system, or various inter-process communication mechanisms in an upper user space.

According to the configuration, whether early warning is needed is determined. If so, the monitoring program triggers a broadcast event, and then the information processing program starts processing.

(1) Each information processing program (that is, monitor) registers monitoring events. The events can come from broadcasts of the information monitoring program or other related underlying drivers.

(2) After receiving the events, each information processing program parses the original event content, filters out the required field information, and performs corresponding preprocessing. For example:
original content of service life information event (for example only):
change @/devices/virtual/eMMC_notify/eMMC_notify ACTION=change DEVPATH=/devices/virtual/eMMC_notify/eMMC_notify SUB SYSTEM=eMMC_notify eMMC service life=0x01 SEQNUM=4791
the required field “eMMC service life=0x01” can be parsed therefrom as valid information;
original content of access information event (for example only):
change @/devices/virtu al/eMMC_notify/eMMC_notify ACTION=change DEVPATH=/devices/virtual/eMMC_notify/eMMC_notify SUB SYSTEM=eMMC_notify TYPE=BLOCK BLOCK_OP=READ SIZE=114 SEQNUM=5012
the required field “TYPE=BLOCK BLOCK_OP=READ SIZE=114” can be parsed therefrom, where SIZE here refers to the number of accessed data blocks, which can be preprocessed and converted into a more appropriate unit for the convenience of users, such as the number of bytes, that is, 114 (blocks)*512 (bytes/block)=58,368 bytes=57 kilobytes, and the converted unit is taken as the final valid information.

(3) The valid information is stored in the database. Besides the content acquired from the monitoring events in step (2), some additional information is stored, such as the time of acquiring the event, the information of the device and so on.

(4) When an external device (e.g. end user) needs to check, relevant data are captured from the database and displayed.

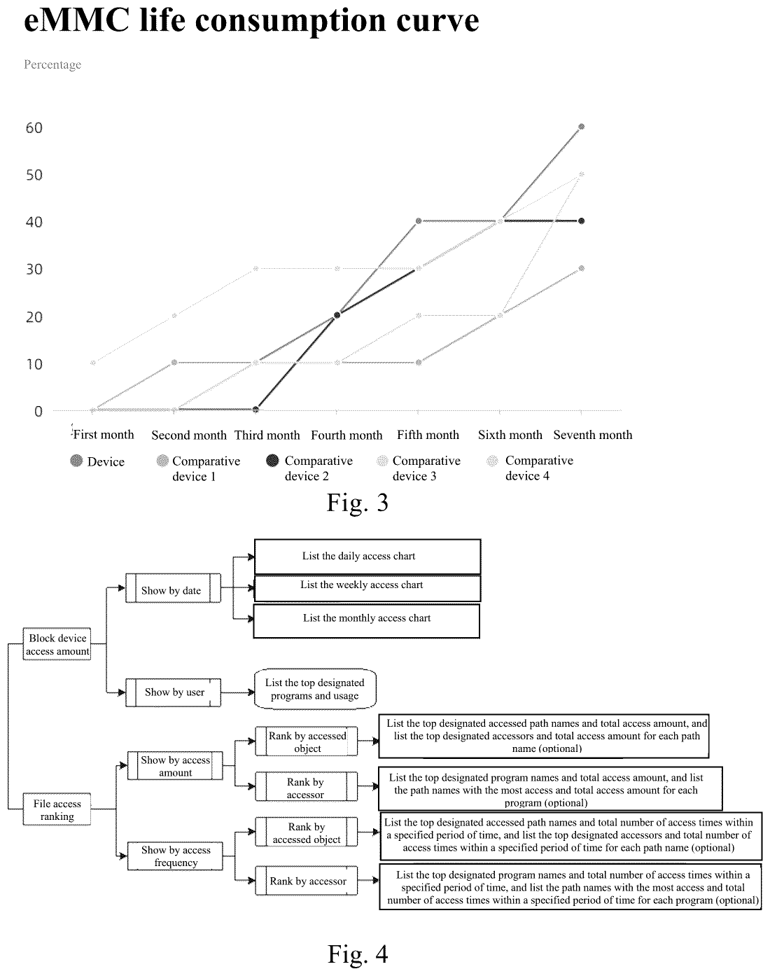

30 FIG. 3 shows a diagram of an eMMC service life loss curve according to an exemplary embodiment of the application.

Referring to FIG. 3, the service life loss curve shown in this example shows the service life information data of this device and other comparative devices in different time periods from two dimensions: device and time, so that the user can learn the use and consumption of eMMC storage devices more comprehensively.

For non-individual users, such as purchasing units of raw materials, the “service life loss curve” provided in this application can be considered as an evaluation factor during purchasing, and the degrees of life reduction of different chips under the same environment, configuration and using habits can be checked. In this way, raw materials with higher durability can be selected and the overall product quality can be improved.

For R&D units, if eMMC over-consumption occurs for devices, the “service life loss curve” in this application helps to determine whether the problem is an individual problem or a universal problem, and “access status statistics” helps to locate the occurrence law of the problem.

FIG. 4 shows a diagram of an access statistics display mode according to an exemplary embodiment of the application.

FIG. 4 is an example of an access statistics display mode. In actual development, the specific display mode can be designed by a developer.

Various “access status information providers” in an operating system are required to be able to acquire the reading and writing operations on eMMC or UFS. After an information provider runs, there are generally the following ways to acquire and process the relevant information of the access status:
actively collecting information after running, triggering an interrupt or reminder after collection, and actively notifying an upper processing program for processing;
staying on standby after running, waiting for a request from an upper processing program, and then immediately acquiring relevant information after receiving the request and sending the information back to the upper processing program; and
actively collecting information after running, and then temporarily storing the information in some fixed locations (for example, recording the information in a file with a specified path or storing the information in a global database), wherein the upper processing program can directly access these fixed locations at any time, thus acquiring the information.

When an external device (e.g. end user) needs to check, the upper processing program acquires relevant data and displays the data. “Displaying statistical reports” means:
(1) if there is early warning information (as mentioned above, whether early warning is needed here is optional), the user will be informed as soon as the early warning information is received; and
(2) in addition to directly displaying the total amount, filtering and ranking ways can be provided for the convenience of the user.

Filtering: Filter condition can be specified, such as date, accessed object, accessor, quantity (greater than or less than) and so on.

Ranking: Displaying can be done in order according to specified criteria. Because there are many items, only the top designated items can be listed as appropriate.

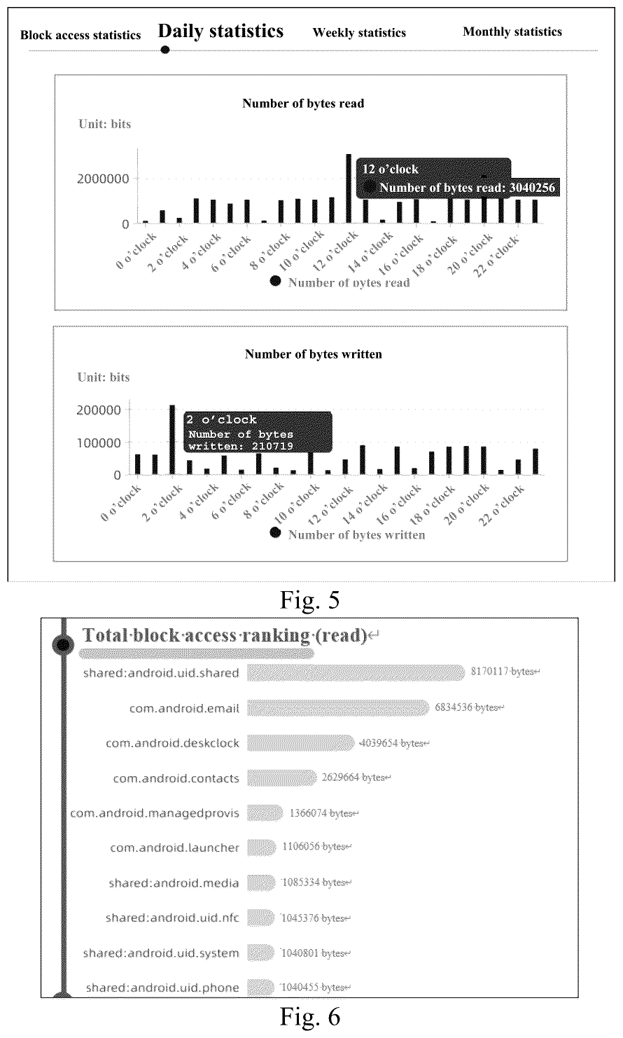

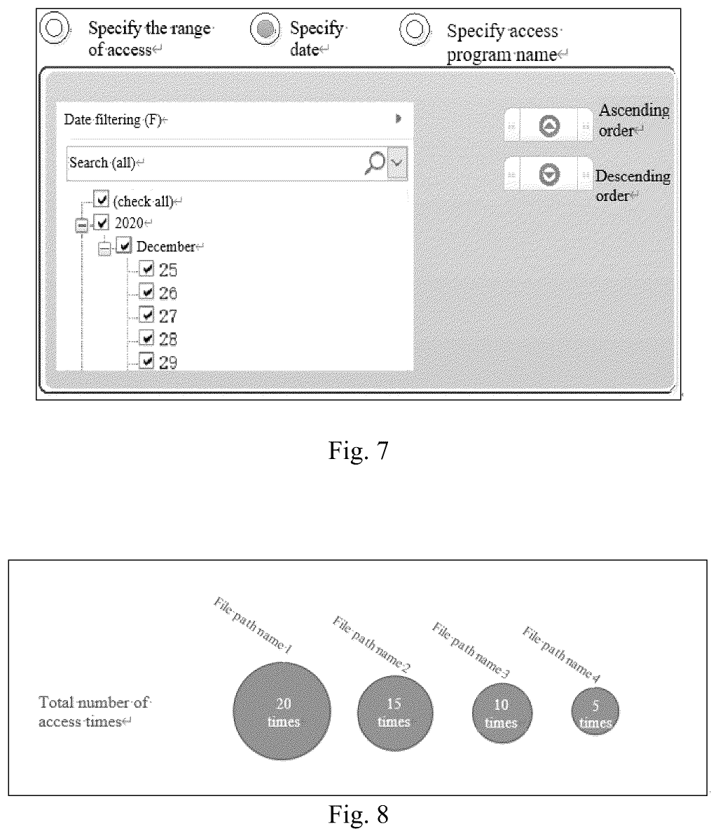

Specifically, block device access statistics by date are shown in FIG. 5, block device access statistics by usage ranking are shown in FIG. 6, block device access statistics by filtering/ranking condition are shown in FIG. 7, and file access ranking by accessor frequency is shown in FIG. 8. After clicking the circle of times, more specific information about each access can be listed according to the actual collection capacity of the platform system, such as access program name, access date, operation description (reading or writing) and so on.

Users can view the gathered access information, including program access frequency ranking, access statistics in each time period, etc., so as to understand the possible reasons for shortening the service life of eMMC and evaluate and improve their device using habits. To some extent, this can indirectly slow down the consumption of eMMC in the future.

It should be clearly understood that this application describes how to form and use specific examples, but this application is not limited to any details of these examples. On the contrary, based on the teachings of the disclosure, these principles can be applied to many other embodiments.

Those skilled in the art can understand that all or part of the steps to implement the above-mentioned embodiments are implemented as computer programs executed by a CPU. When the computer programs are executed by a CPU, programs for executing the above functions defined by the above method provided by the application can be stored in a computer-readable storage medium, which can be a read-only memory, a magnetic disk or an optical disk, etc.

In addition, it should be noted that the above drawings are only illustrations of the processes included in the method according to the exemplary embodiments of the application, and are not for limiting purposes. It is easy to understand that the processes shown in the above figures do not indicate or limit the time sequence of these processes. In addition, it is also easy to understand that these processes can be performed synchronously or asynchronously in multiple modules, for example.

Through the description of the exemplary embodiment, those skilled in the art can easily understand that the monitoring method for an electronic device according to the embodiment of the application has at least one or more of the following advantages.

According to exemplary embodiments, through real-time monitoring on an electronic device with an embedded flash memory module, when the service life loss of the embedded flash memory reaches a preset range or the usage status of the embedded flash memory reaches a preset condition, a user can be warned and provided with a viewing interface.

According to exemplary embodiments, the idea of “access status statistics” is provided. After receiving the warning, users can view the gathered access information, including program access frequency ranking, access statistics in each time period, etc., to help users understand the possible reasons for shortening the service life of eMMC and also help users evaluate and improve their device using habits. To some extent, this can indirectly slow down the consumption of eMMC in the future.

A device embodiment of the application is described below, which can be used to execute the method embodiment of the application. For details not disclosed in the device embodiment of the application, please refer to the method embodiment of the application.

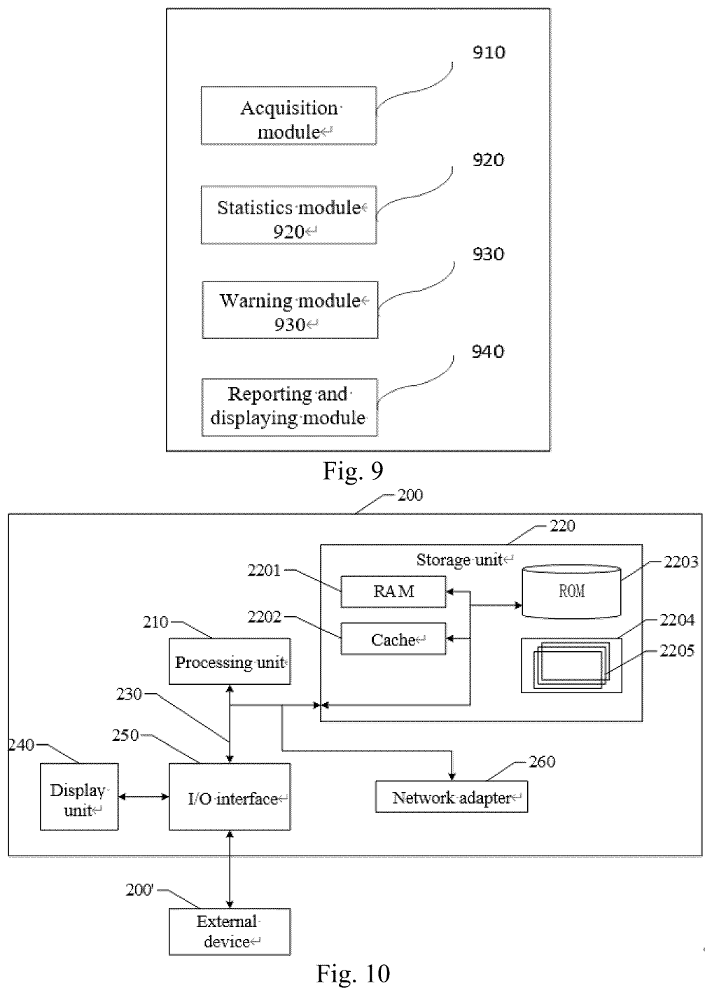

FIG. 9 shows a block diagram of a monitoring apparatus for an electronic device according to an exemplary embodiment. The apparatus shown in FIG. 9 can execute the aforementioned monitoring method for an electronic device according to an embodiment of the application.

As shown in FIG. 9, the monitoring apparatus for an electronic device may comprise an acquisition module 910, a statistics module 920, a warning module 930, and a reporting and displaying module 940.

Referring to FIG. 9 and the previous description, the acquisition module 910 is used for acquiring service life data and access status data of the embedded flash memory;
the statistics module 920 is used for performing statistics on the access status data to obtain a statistical result of the access status;
the warning module 930 is used for generating early warning information if it is determined according to the service life data and/or the access status data that early warning condition is met; and
the reporting and displaying module 940 is used for reporting and displaying the service life data and the statistical result of the access status according to the early warning information.

The apparatus performs functions similar to those provided above, and with respect to other functions, please refer to the previous description, and not repeated here.

FIG. 10 is a block diagram of an electronic device according to an exemplary embodiment.

An electronic device 200 according to this embodiment of the application will be described below with reference to FIG. 10. The electronic device 200 shown in FIG. 10 is only an example, and should not impose any restrictions on the functions and application scope of the embodiment of the application.

As shown in FIG. 10, the electronic device 200 is represented in the form of a general-purpose computing device. Components of the electronic device 200 may comprise, but are not limited to, at least one processing unit 210, at least one storage unit 220, a bus 230 connecting different system components (including the storage unit 220 and the processing unit 210), a display unit 240, etc.

The storage unit stores a program code, and the program code can be executed by the processing unit 210, so that the processing unit 210 performs the methods described in this specification according to various exemplary embodiments of the application.

The storage unit 220 may comprise a readable medium in the form of a volatile memory cell, such as a random access memory (RAM) 2201 and/or a cache memory 2202, and may further comprise a read-only memory (ROM) 2203.

The storage unit 220 may also comprise a program/utility tool 2204 with a group of (at least one) program modules 2205, such program modules 2205 include but are not limited to: an operation system, one or more application programs, other program modules and program data, and each or some combination of these examples may include the implementation of a network environment.

The bus 230 may represent one or more of several types of bus structures, including memory cell bus or memory cell controller, peripheral bus, graphics acceleration port, processing unit or local bus using any of a variety of bus structures.

The electronic device 200 can also communicate with one or more external devices 300 (e.g., keyboard, pointing device, Bluetooth device, etc.), with one or more devices that enable users to interact with the electronic device 200, and/or with any device that enables the electronic device 200 to communicate with one or more other computing devices (e.g., routers, modems, etc.). This communication can be performed through an input/output (I/O) interface 250. Further, the electronic device 200 can also communicate with one or more networks (such as a local area network (LAN), a wide area network (WAN) and/or a public network, such as the Internet) through a network adapter 260. The network adapter 260 can communicate with other modules of the electronic device 200 through a bus 230. It should be understood that although not shown in the figure, other hardware and/or software modules can be used in conjunction with the electronic device 200, including but not limited to microcodes, device drivers, redundant processing units, external disk drive arrays, RAID systems, tape drives, data backup storage systems, etc.

Through the description of the above embodiments, it is easy for those skilled in the art to understand that the exemplary embodiments described here can be implemented by software or by software combined with necessary hardware. The technical solutions according to the embodiments of the application may be embodied in the form of a software product, which may be stored in a non-volatile storage medium (which may be a CD-ROM, USB flash drive, mobile hard drive, etc.) or on a network, and may include several instructions to enable a computing device (which may be a personal computer, server, or network device, etc.) to execute the method according to the embodiments of the application.

A software product can adopt any combination of one or more readable media. The readable medium may be a readable signal medium or a readable storage medium. The readable storage medium can be, for example, but is not limited to, an electrical, magnetic, optical, electromagnetic, infrared, or semiconductor system, apparatus or device, or a combination of any of the above. More specific examples (a non-exhaustive list) of readable storage media include: electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The computer-readable storage medium may be a data signal propagated in a baseband or as part of a carrier wave, in which a readable program code is contained. This propagated data signal can take many forms, including but not limited to electromagnetic signal, optical signal or any suitable combination of the above. The readable storage medium may also be any readable medium other than the readable storage medium, which can send, propagate or transmit a program for use by or in combination with an instruction execution system, apparatus or device. The program code contained in the readable storage medium can be transmitted by any suitable medium, including but not limited to Wi-Fi, wire, optical cable, RF, etc., or any suitable combination of the above.

Computer program codes for performing the operations of the disclosure can be written by a combination of one or more programming languages, including object-oriented programming languages such as Java, C++, and conventional procedural programming languages such as “C” language or similar programming languages. The program code can be completely executed on user computing equipment, partially executed on user equipment, executed as an independent software package, partially executed on user computing equipment and partially executed on remote computing equipment, or completely executed on remote computing equipment or a server. In a case involving remote computing equipment, the remote computing equipment may be connected to user computing equipment through any kind of network including a local area network (LAN) or a wide area network (WAN), or may be connected to external computing equipment (e.g., connected through the Internet using an Internet service provider).

The application provides a monitoring method and apparatus for an electronic device, which are used for monitoring the service life of an embedded flash memory in real time and acquiring the usage status of the embedded flash memory. When a preset warning condition is met, early warning information is sent to a user, and corresponding data are displayed to the user through a user-friendly interface. By viewing the gathered access information, including program access frequency ranking, access statistics in each time period, etc., users can learn the possible reasons for shortening the service life of the embedded flash memory, and can be helped to evaluate and improve their device using habits, so as to indirectly slow down the loss of the flash memory to a certain extent in the future.

Those skilled in the art can understand that the above modules can be distributed in devices according to the description of the embodiment, or can be uniquely arranged in one or more devices of this embodiment with corresponding changes. The modules in the above embodiments can be merged into one module or further split into multiple submodules.

Exemplary embodiments of the application have been particularly shown and described above. It should be understood that this application is not limited to the detailed structure, arrangement or implementation described here; on the contrary, this application is intended to cover various modifications and equivalent arrangements included within the spirit and scope of the appended claims.

1-13. (canceled)

14. A monitoring method for an electronic device configured with an embedded flash memory, the method comprising:
acquiring service life data and access status data of the embedded flash memory;
performing statistics on the access status data to obtain a statistical result of the access status;
generating early warning information if it is determined according to the service life data and/or the access status data that an early warning condition is met; and
reporting and displaying the service life data and the statistical result of the access status according to the early warning information.

15. The method according to claim 14, further comprising: acquiring the service life data and the statistical result of the access status in response to a search request.

16. The method according to claim 14, further comprising: storing the service life data and the access status data in a database.

17. The method according to claim 14, wherein reporting and displaying the service life data and the statistical result of the access status comprises:
displaying a change of the embedded flash memory itself based on time span.

18. The method according to claim 17, wherein reporting and displaying the service life data and the statistical result of the access status further comprises:
displaying a service life loss status compared with other embedded flash memories.

19. The method according to claim 14, wherein reporting and displaying the service life data and the statistical result of the access status further comprises:
filtering the service life data and the access status data according to different filtering conditions.

20. The method according to claim 14, wherein reporting and displaying the service life data and the statistical result of the access status further comprises:
displaying the service life data and the access status data in sequence according to specified criteria.

21. The method according to claim 14, further comprising:
monitoring the early warning information and acquiring the service life data and the access status data; and
notifying or sharing the early warning information and/or the acquired service life data and access status data to other monitors or devices.

22. The method according to claim 21, wherein a plurality of monitor processes performs the monitoring at the same time.

23. The method according to claim 22, further comprising:
acquiring an instruction of the monitor and processing the acquired service life data and access status data to protect the embedded flash memory.

24. An electronic device, comprising:
a memory, a processor and a computer program stored in the memory and runnable on the processor, wherein the processor executes the computer program to implement the method according to claim 14.

25. A computer program product, comprising computer programs or instructions that are executed by a processor to implement the method according to claim 14.
